(19) United States
(12) Patent Application Publication
(10) Pub. No.: US 2018/0171563 A1
(43) Pub. Date: Jun. 21, 2018

(54) TRANSPARENT SOUND-ABSORBING NOISE PROTECTION ELEMENT

(71) Applicant: Evonik Röhm GmbH, Darmstadt (DE)

(72) Inventors: Gerd JONAS, Seeheim (DE); Peter Seelmann, Wien (AT)

(73) Assignee: Evonik Röhm GmbH, Darmstadt (DE)

(21) Appl. No.: 15/846,034

(22) Filed: Dec. 18, 2017

(30) Foreign Application Priority Data
Dec. 19, 2016 (EP) 16204931

(51) Int. Cl. E01B 19/00; G10K 11/162

(52) U.S. Cl. CPC E01B 19/003; G10K 11/162

(57) ABSTRACT

A noise protection element for the insulation and absorption of sound emissions from vehicles, more particularly road vehicles and railway vehicles and also aeroplanes moving along a traffic route. The noise protection element includes a plate having a transparent material, where a noise-absorbing material has been applied on at least one of the two surfaces of the plate, where the noise-absorbing material is a closed-pore polymer foam.

### CROSS REFERENCE TO RELATED APPLICATIONS

This application claims foreign priority to European patent application EP16204931, filed on Dec. 19, 2016, the text of which is also incorporated by reference.

The present invention relates to a noise protection element for the insulation and absorption of sound emissions from vehicles, more particularly motorized vehicles moving along a traffic route.

The building of noise protection barriers on public traffic routes frequently employs the installation of transparent elements composed of safety-glass panes, laminated safety glass, polycarbonates or acryl glass. Such elements are usually referred to as sound-insulating or sound-reflecting elements. In practice, solid plates in thicknesses of 8-30 mm are generally involved. Although said plates have a high level of airborne sound insulation, they cannot be used in all situations owing to their sound-reflecting properties.

The transparent sound-absorbing elements currently on the market are distinguished by the fact that a specific noise-absorbing frame system or absorbing pillar/post system which has noise-absorbing properties is used for the acoustically hard surface of the transparent element such as, for example, glass, acryl glass or polycarbonate. Although such elements have a very good sound absorption in a reverberation room (testing in accordance with DIN EN 1793 part 1 and 2), they do not when used along a traffic route, where these transparent noise-absorbing walls do not exhibit a sufficient sound-absorption effect.

Another design of noise-absorbing elements is based on the cassette system, as is customary in aluminium or wooden walls for example. The cassette is one that has a transparent front side having openings and a compact rear side composed of transparent material having no openings. The perforated front side of such an element is based on marketable aluminium elements and has openings which can have different shapes and sizes. Round or elongated openings or else circularly arranged slits in the transparent plate are known.

Other technical solutions are based on the principle of Helmholtz resonators and exhibit sound absorption only in certain frequencies. Such systems have been known for years; however, either the sound properties of the elements or the actual effectiveness and long-term resistance is lacking. Moreover, such systems are not suitable for absorbing the entire spectrum of traffic noises.

A further design of a transparent noise-absorbing element is the so-called CLEARWALL® system. This system of complex construction consists of transparent panes, in front of which perforated aluminium struts having noise-absorbing properties are mounted perpendicularly to the plate surface.

A corresponding arrangement is described in utility model document DE 200 21 724 U1. The document discloses a noise protection barrier having a transparent wall part and sound-absorbing lamellae which protrude from a side of the wall part that is pointing to a source of sound. The lamellae generally have cladding which is at least partly filled with a sound-absorbing material, which can be mineral wool, mineral film or an open-pore foam. The cladding of the lamellae can consist of metal sheets provided with openings.

DE 200 21 724 U1 concedes that the sound-absorbing materials used are soft and not very robust and can therefore be processed to form lamellae sufficiently robust with respect to environmental influences only with use of an additional cladding. Since the cladding of the lamellae consists of comparatively heavy metal sheets, their attachment requires special clamping or screw elements which must be suitable for the not inconsiderable weight of the lamellae.

Therefore, the noise protection barrier of DE 200 21 724 U1 has altogether a not inconsiderable weight, this being a disadvantage especially when used on bridge sections. Furthermore, the production and assembly of appropriate noise protection barriers is labour- and cost-intensive.

JP 2002-201613 describes a similarly constructed noise protection element in which a fibrous noise-absorbing material is accommodated in noise-absorbing cassettes. The noise-absorbing material can be polyester fibre, polypropylene fibre, polyethylene fibre, nylon fibre and also cotton fibre or metal fibre. Similar to the noise protection barrier of DE 200 21 724 U1, the cladding of the noise-absorbing cassettes has multiple openings.

JP 2002-138421 describes a translucent sound-absorption body comprising a translucent plate element and at least one sound-absorption body arranged on the top edge and/or on the bottom edge of the translucent plate element in order to absorb the sound reflected by the translucent plate element.

What is common to the systems described above is that they are comparatively complex in terms of their construction and production and, accordingly, expensive. In addition, it has become apparent that it is possible to further improve such sound-control elements with respect to their sound insulation and, in particular, sound-absorption properties when used along a traffic route.

It is therefore an object of the present invention to provide a simple-to-produce and at least partly transparent noise protection element which, with a relatively low space requirement and comparatively low weight when used along a traffic route, exhibits excellent sound absorption and, at the same time, relatively low sound reflection.

It is a further object of the present invention to provide a noise protection barrier which comprises an at least partly transparent noise protection element, and exhibits excellent sound-insulating properties and low sound reflection. What is important here is that the noise protection barrier efficiently absorbs essentially the entire spectrum of traffic noises when used on the edge of a traffic route.

According to the invention, these objects were achieved in a surprisingly simple manner by the noise protection element according to the invention and the noise protection barrier according to the invention.

The noise protection element according to the invention is distinguished by the fact that the desired sound absorption, in line with the new acoustics standards 1793-5 and 1793-6 (measurement of in situ airborne sound insulation), is achieved directly on the transparent solid plate. Generally, the noise-absorbing material is evenly distributed across the plate and thus exhibits very good sound absorption values across the entire spectrum of traffic noises.

### BRIEF DESCRIPTION OF THE DRAWINGS

FIG. 1A, FIG. 1B, FIG. 1C and FIG. 1D shows different views of the plates.

FIG. 2 shows a noise protection element according to one embodiment of the invention.

FIG. 3 is a graph illustrating acoustic properties of the noise protection element of Example 1.

FIG. 4 is a graph illustrating acoustic properties of the noise protection elements of Examples 1 and 2 as well as of commercially available noise protection elements DIESELBOX and ALPHA.

FIG. 5 is an image of stripes of noise-absorbing material for use in the noise protection element.

The noise protection element 1 according to the invention comprises a plate 2 composed of a transparent material, wherein a noise-absorbing material 3 has been applied to at least one of the two surfaces of the plate. According to the invention, the noise-absorbing material can be secured on the plate by means of an adhesive or adhesive mounting tape, be inserted into recesses in the plate that are optionally present, or be applied to the surface of the plate by another method.

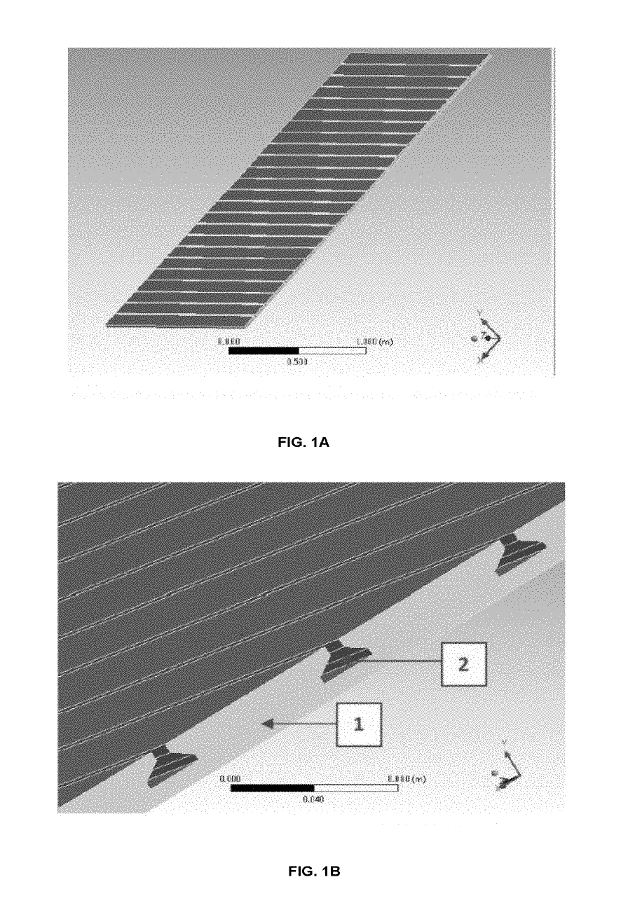

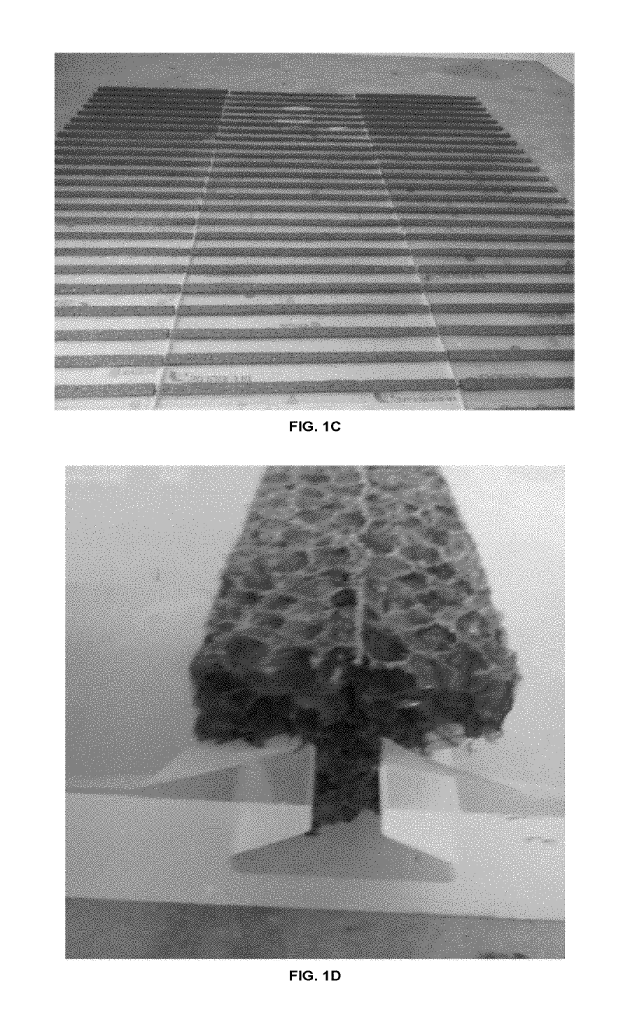

FIG. 1A shows a plate of a transparent material comprising a plurality of recesses running in parallel to each other. In one embodiment of the invention, the noise-absorbing material is inserted into the plurality of recesses. FIG. 1B shows a close view of the plate 1 shown in FIG. 1A having a plurality of recesses 2. FIG. 1C shows a noise protection element comprising a transparent plate which has a plurality of recesses. The elements of the noise-absorbing material have been attached to the transparent plate by inserting them into the recesses. FIG. 1D shows a close view of an element of the noise-absorbing material inserted into a recess in the plate.

Particularly preferred embodiments of the noise protection element 1 according to the invention and also the possible uses thereof are as follows:

[1] Noise protection element 1 comprising a plate 2 composed of a transparent material, characterized in that a noise-absorbing material 3 has been applied on at least one of the two surfaces of the plate 2.

[2] Noise protection element 1 according to [1], in which the transparent material comprises a polymer selected from polyalkyl (meth)acrylate, polycarbonate and polyalkyl (meth)acrylimide.

[3] Noise protection element 1 according to [1] or [2], in which the transparent material comprises polymethyl methacrylate.

[4] Noise protection element 1 according to at least one of [1] to [3], in which at least one of the two surfaces of the plate 2 is at least partly matted and/or the plate 2 contains a particulate scatterer.

[⁵] Noise protection element 1 according to at least one of [1] to [4], in which the noise-absorbing material 3 is a polymer foam, preferably a polyolefin foam.

[6] Noise protection element 1 according to at least one of [1] to [5], in which the noise-absorbing material 3 forms on at least one side of the plate 2 a regular or irregular pattern in the form of trees, bushes, branches or geometric shapes such as circles, triangles, rectangles or hexagons.

[7] Noise protection element 1 according to at least one of [1] to [6], in which the noise-absorbing material 3 has been applied on at least one side of the plate 2 in the form of multiple strips arranged in parallel to one another.

[8] Noise protection element 1 according to at least one of [1] to [7], in which the side of the plate 2 to which a noise-absorbing material 3 has been applied has multiple recesses 4 which have been at least partly covered and/or filled by the noise-absorbing material 3.

[⁹] Noise protection element 1 according to [8], in which the recesses 4 form a pattern composed of straight lines running in parallel to one another, which lines extend across the entire surface of the plate.

[10] Noise protection element 1 according to [8] or [9], in which the recesses 4 have a triangular, trapezoidal, funnel-shaped, oval or rectangular cross section.

[11] Noise protection element 1 according to at least one of [1] to [10], in which from 10% to 50% of at least one surface of the plate 2 is covered by the noise-absorbing material 3.

[12] Use of a noise protection element 1 according to at least one of [1] to [11] for noise insulation in a noise protection barrier.

[13] Noise protection barrier for the insulation of sound emissions of a traffic route, which noise protection barrier comprises the noise protection element 1 according to at least one of [1] to [11], wherein the noise-absorbing material 3 has been applied to a traffic route-facing surface of the plate 2 composed of a transparent material.

The transparent material can be inorganic glass or an organic polymer. The inorganic glass used can be, in particular, silicate glass. A suitable organic polymer can be, in particular, a polymer comprising a polycarbonate, polyalkyl (meth)acrylate such as, for example, polymethyl methacrylate (PMMA), a polymethyl methacrylimide (PMMI) or mixtures thereof. In a preferred embodiment, the organic polymer substantially consists of polycarbonate, PMMA or PMMI.

In a particularly preferred embodiment, the transparent material is PMMA. Appropriate materials are commercially available from Evonik Performance Materials GmbH (Darmstadt, Germany) under the brand name PLEXIGLAS®. Customarily, appropriate plates composed of PMMA are produced by extrusion or according to the chamber casting method from methyl methacrylate. In the case of the latter, the liquid polymerizable monomer mixture is filled into a flat chamber formed from two parallel glass plates and a sealing strip running around thereinbetween on the edge. After the fill-in opening has been closed, the filled chamber is exposed to the polymerization conditions until the monomer mixture has been hardened to form PMMA.

Commercially available PLEXIGLAS® Soundstop plates are particularly well suited for use in the noise protection element according to the invention. They can optionally be reinforced by embedded polyamide or steel threads or by a fabric mesh composed of such threads, the result being that loose fragments of such a plate in the event of damage are prevented from forming and falling down. Appropriate PMMA plates are, for example, described in the patent specification DE 199 47 704 B4.

The transparent materials used can also be composites, provided they have a sufficiently high transparency. Preferably, the transparent material has a luminous transmittance D₆₅, measured in accordance with ISO 13468-2, of at least 70%, preferably at least 80%, particularly preferably at least 90%.

In one embodiment, at least one of the two surfaces of the plate can be at least partly matted or satin-matted, i.e. be constituted such that the plate is light-permeable, but not see-through. This effect can be achieved by dulling or colouring the transparent material or by processing the surface of the plate. The satin-matting of a glass surface can, for example, be achieved by roughening with the aid of a sandblasting technique or treatment with hydrofluoric acid. Plates composed of a polymeric material such as PMMA can be matted or satin-matted by mechanical, thermoplastic or chemical matting methods. Appropriate methods are known to a person skilled in the art. Mechanical matting methods can, for example, be sandblasting, sanding with sanding paper and sanding fabrics or with rotating brushes. An example of thermoplastic matting that can be mentioned is thermoforming matting. Matting with chemical substances, such as solvents, is likewise possible. They dissolve into the polymeric transparent material such as PMMA and thus structure the surface of the plate.

When producing extruded plates composed of a polymeric material such as PMMA, it is possible to impress matted structures into smooth extruded film webs by means of roughened embossing rollers in a roller calender. By contrast, when producing the plate according to the chamber casting method, the inner side of at least one of the two glass plates can have a rough surface and thus generate a matted structure on the corresponding surface of the plate. Both methods are well known to a person skilled in the art.

In a further embodiment, matting agents, for example particulate scatterers, can be added to the transparent material. This approach is particularly well suited for the production of extruded plates composed of PMMA that consist of a matted layer. Alternatively, the plate can be a multilayer co-extruded plate which comprises a base layer containing no particulate scatterers and at least one scattering layer containing a particulate scatterer.

The noise-absorbing material used according to the invention is a closed-pore polymer foam, for example a closed-pore polyolefin foam, closed-pore polyurethane foam or a closed-pore polyalkyl (meth)acrylimide foam.

A closed-pore polyolefin foam can, for example, be a closed-pore polystyrene foam, a closed-pore polyethylene foam or a closed-pore polypropylene foam, the closed-pore polyethylene foam and the closed-pore polypropylene foam being particularly well suited for the use according to the invention owing to their excellent weathering stability.

In the present application, a closed-pore polyethylene foam or a closed-pore polypropylene foam is understood to mean a closed-pore foam, the polymer component of which comprises polyethylene or polypropylene. The polymer component can be pure polyethylene or polypropylene, a copolymer of ethylene or propylene, or a mixture of polyethylene or polypropylene with at least one further polymer.

Examples of suitable closed-pore polymer foams that can be mentioned are Ethafoam Whisper®, Stratocell Whisper® FR or Stratocell Whisper® DB, which are commercially available from Sealed Air (NC, USA).

In comparison with other noise-absorbing materials in the prior art, closed-pore polymer foams offer numerous technical advantages when used in the noise protection element according to the invention. Closed-pore polymer foams generally have a substantially higher mechanical strength than comparable open-pore foams or fibrous materials. Furthermore, the uptake of water and dirt by such a polymer foam is distinctly lower than in materials that are customarily used. The surface area-based water uptake of the polymer foam used owing to diffusion in accordance with EN 12088 (RH>95%, 28 days) is generally not higher than 10 kg/m², more preferably not higher than 5 kg/m², particularly preferably not higher than 3 kg/m².

For this reason, it is possible to use elements composed of a closed-pore polymer foam without the cladding sheets customary in the prior art. This allows a significant reduction in the weight of the entire noise protection element. Thus, the noise protection element according to the invention has a particularly low weight and is suitable especially for bridge sections, where the load on the bridge is to be kept as low as possible.

Additionally, the handling of components composed of a closed-pore polymer foam is substantially simpler than in the case of comparable noise-absorbing materials of the prior art. In particular, elements composed of a closed-pore polymer foam can be secured on the surface of the plate with a low level of effort and expenditure, for example by means of an adhesive or a double-sided adhesive tape. Because the use of special clamping or screw elements at this site is no longer required, it is possible to additionally reduce the weight of the noise-absorbing element.

The use of a closed-pore polymer foam as noise-absorbing material is not customary, because it has so far been assumed by the experts that the presence of open pores in a polymer foam is necessary for an efficient sound absorption. This view is, for example, expressed in the Kirk-Othmer Encyclopedia of Chemical Technology, “Polymeric foams” and in Ullmann's Encyclopedia of Industrial Chemistry, “Foamed Plastics”.

Closed-pore polymer foams are well known to a person skilled in the art and are described inter alia in standard reference books such as Kirk-Othmer Encyclopedia of Chemical Technology, “Polymeric foams” or in Ullmann's Encyclopedia of Industrial Chemistry, “Foamed Plastics”.

A closed-pore polymer foam is understood to mean a polymer foam in which the trapped gas phase is largely present in the form of closed-off individual cells. The walls between the individual cells are completely closed. In the context of the present invention, a closed-pore polymer foam is understood to mean a polymer foam in which the proportion of open cells is not higher than 50%, preferably not higher than 40%, particularly preferably not higher than 30%, yet more preferably not higher than 20%, yet more preferably below 10% and very particularly preferably below 5%. The proportion of open cells in the polymer foam can be determined in accordance with the standard ASTM D6226-10, for example by using nitrogen as test gas.

In particular, it is preferred that at least the plate-facing surface of the noise-absorbing material is virtually completely closed-pore. As a result, it is possible inter alia to realize a particularly stable adhesive bond between the noise-absorbing material and the plate.

The nominal density of the polymer foam used, measured in accordance with ISO 845:2006, is typically between 5 and 100 kg/m³, preferably between 10 and 70 kg/m³, particularly preferably between 20 and 50 kg/m³ and very particularly preferably at between 20 and 40 kg/m³.

The polymer foam used according to the invention generally has good noise-absorbing properties. It is preferred that a 50 mm sample of the polymer foam when measured in accordance with EN ISO 11654 has a degree of sound absorption α_{W} of at least 0.6, more preferably at least 0.7, yet more preferably at least 0.8, yet more preferably at least 0.9 and particularly preferably at least 0.95. These values correspond to sound absorber class C, more preferably sound absorber class B and particularly preferably sound absorber class A.

In one embodiment, the polymer foam used can have a largely uniform pore size between 0.5 mm and 30 mm, more preferably between 1 mm and 20 mm, yet more preferably between 1 mm and 15 mm. What is particularly advantageous for the absorption of typical frequencies of traffic noise is a pore-size distribution between 1 mm and 10 mm.

In an alternative embodiment, the polymer foam used has a pore size between 0.5 mm and 30 mm, wherein about 30% of pores are of a size between 0.5 mm and 5 mm, a further 30% are of a size between 5 mm and 10 mm, and a further 40% are of a size between 10 mm and 30 mm. A distribution of this kind allows a particularly efficient absorption of the entire spectrum of traffic noises.

In a preferred embodiment, the noise-absorbing material is applied to the plate in the form of multiple strips. In this connection, the strips composed of the noise-absorbing material can be arranged in parallel to one another, for example arranged largely horizontally, diagonally or vertically, in parallel to the traffic route. When the transparent material used is a PMMA plate reinforced with threads, the strips composed of the noise-absorbing material can be applied such that the threads are at least partly covered by the parallel strips composed of the noise-absorbing material and are not visible to the observer.

At least one surface of the plate composed of a transparent material can have multiple recesses. The cross section of the recesses can, for example, be triangular, trapezoidal, funnel-shaped, oval or rectangular. Said recesses can be incorporated into the plate as early as during the production of the plate, for example during the extrusion, or else afterwards into a pre-manufactured plate, for example by milling. Thereafter, elements composed of the noise-absorbing material can be inserted into the prepared recesses. Furthermore, it is possible that the noise-absorbing material such as foam is polymerized into the plate as early as during the production thereof.

When the noise protection element is used according to the invention, the recesses are oriented in the direction of the source of noise (traffic route) and contribute significantly to the absorption of noise. The recesses in the plate can be at least partly covered and/or filled by the noise-absorbing material. In the latter case, the recesses serve not only as Helmholtz resonators, but also as anchoring for elements composed of the noise-absorbing material.

In a further embodiment, the plate composed of a transparent material does not have any recesses. The noise-absorbing material, typically a polyolefin foam, can be applied directly to the surface of the plate, for example with the aid of an adhesive or an adhesive mounting tape. Because no recesses are necessary for this purpose, the production costs for the corresponding noise protection element are distinctly lower. Furthermore, it is possible to apply the noise-absorbing material to noise protection elements which have already been installed into noise protection barriers.

Furthermore, the noise-absorbing material can form non-linear regular or irregular patterns in the form of trees, bushes, branches or geometric shapes such as circles, triangles, rectangles or hexagons.

Furthermore, it is possible for the noise-absorbing material in the form of strips varying in width and arranged at varying intervals to be applied to the surface of the plate, horizontally, diagonally or vertically to one another. Through the adjustment of intervals between the strips, it is possible to additionally optimize the noise absorption for certain frequencies.

In a particularly preferred embodiment, the recesses form a pattern composed of multiple straight lines running in parallel to one another, for example horizontally, which lines extend across the entire surface of the plate. The strip-shaped elements composed of the noise-absorbing material that are anchored therein are thus likewise oriented in parallel to one another. Particularly well suited as noise-absorbing materials for this embodiment are, in particular, polyolefin foams, the use of polyethylene foams having been found particularly advantageous.

So that an optimal sound absorption can be achieved, the noise-absorbing material is distributed as evenly as possible on the surface of the plate.

The part of the polyolefin foam protruding above the surface of the plate can have different geometries and sizes. It can be rectangular, triangular, trapezoidal, semicircular, oval or have any other shape having a structured surface shape, for example lamellar shape or Christmas tree shape.

It was found that, surprisingly, an excellent absorption of noise can already be achieved if about 10% to 50%, particularly preferably 20% to 30%, of at least one surface of the plate is covered by the noise-absorbing material. The remaining surface of the plate generally continues to appear transparent to the observer. Thus, the transparency of a noise protection barrier in which the noise protection elements according to the invention are used is maintained to a large extent.

Consequently, the noise protection element according to the invention combines the advantages of completely transparent noise protection elements (such as PLEXIGLAS® Soundstop), as are already known, with those of distinctly more complex noise-absorbing systems which are non-transparent.

What has been found to be additionally advantageous is one embodiment in which the noise-absorbing material is applied to the surface of the plate in the form of multiple strips varying in width and arranged at varying intervals. This arrangement allows a particularly efficient sound absorption in a broad spectrum of frequencies.

In a preferred embodiment, the noise-absorbing material can be coloured in a high-contrast manner. This colouring, for example black colouring, can be used for the design of the noise protection element according to the invention and is, furthermore, suitable as an effective measure for bird protection.

The noise protection element according to the invention can be used in a noise protection barrier for the insulation and absorption of sound emissions from vehicles, more particularly motorized vehicles moving along a traffic route. These encompass, in particular, road vehicles, railway vehicles, magnetic levitation trains and also aeroplanes which are taking off and landing. The road vehicles encompass, in particular, vehicles with a combustion engine, electric drive or a hybrid drive. Railway vehicles can, for example, be trams, trains and high-speed trains. The “traffic route” in the context of the present invention can be a road, a motorway, a railway track (railway line) for transporting passengers and goods, or a take-off and landing runway for civilian and military aeroplanes.

Furthermore, the noise protection element according to the invention can be used in a noise protection barrier for the insulation and absorption of sound emissions from helicopters which are taking off and landing, more particularly on helipads.

The noise protection barrier according to the invention generally comprises multiple noise protection elements according to the invention, which elements are oriented along the traffic route. So that an optimal sound absorption can be achieved, the noise-absorbing material is situated on a traffic route-facing surface of the plate.

Because the noise protection element according to the invention appears largely transparent to the observer in a vehicle, it allows a largely undisturbed view of the surrounding landscape during the journey. At the same time, the noise protection element according to the invention brings about efficient sound absorption and only low sound reflection, meaning that both the vehicle occupants and the surroundings of the traffic route are exposed to a distinctly lower noise level.

### EXAMPLES

### Example 1—Test in Accordance with ISO 354

12 identical 25 mm thick PMMA plates (PLEXIGLAS® Soundstop GS CC, commercially available from Evonik Performance Materials GmbH, length: 1000 mm, height: 1000 mm) were used. The properties of the PMMA plates are compiled below in Table 1:

TABLE 1

| | | |
|---|---|---|
| Density in accordance with ISO 1183 | 1.19 | g/cm³ |
| Weight | 29.7 | kg/m² |
| Tensile strength in accordance with ISO 527-2/1B/5 | 70 | MPa |
| Modulus of elasticity in accordance with ISO 527- | 3300 | MPa |
| 2/1B/5 | | |
| Coefficient of thermal expansion 0° to 50° C. in | 70 × 10⁶ | K⁻¹ |
| accordance with DIN 53752-A | | |

| | |
|---|---|
| Poisson's ratio | 0.37 |

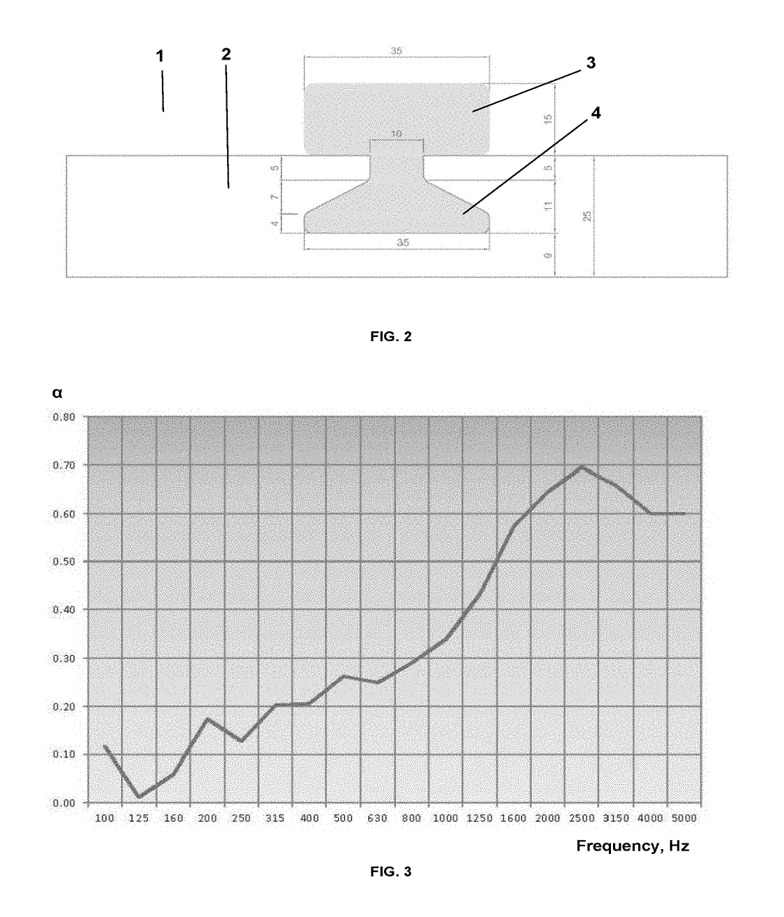

In the plates 2, multiple triangular recesses 4 were milled out at an interval of 125 mm (see FIG. 1A, FIG. 1B, FIG. 10, FIG. 1D and FIG. 2). Foam strips 3 having a 40×40 mm cross section were inserted into the prepared recesses. The foam used was the commercially available polyethylene foam Stratocell Whisper® UV. The characteristics of Stratocell Whisper® UV are listed below:

TABLE 2

| Density in accordance with ISO 845:2006 | 25 | kg/m³ |
|---|---|---|
| (ASTM D3575-08 W) | | |
| Water absorption (RH >95%, after 28 days), | <3 | kg/m² |
| in accordance with UNI EN 12088 | | |
| Thermal conductivity in accordance with | 0.104 W/(m · K) (23° C.) | |
| ISO 845:2006 | 0.082 W/(m · K) (−5° C.) | |
| (ASTM D3573-08 V) | | |
| Thermal stability in accordance with ISO | <3 | |
| 845:2006 (ASTM D3573-08 S) | | |
| Thickness | 40 | mm |

Acoustic properties of the noise protection elements were examined in a test in accordance with ISO 354. Standard ISO 354 describes a method for measuring the sound absorption coefficient of acoustic materials used as wall or ceiling cladding.

The measurement results are compiled in Table 3 and depicted graphically by means of the graph in FIG. 3:

TABLE 3

| | Frequency, Hz | | | | | | | | | | | | | | | | | |
|---|---|---|---|---|---|---|---|---|---|---|---|---|---|---|---|---|---|---|
| | 100 | 125 | 160 | 200 | 250 | 315 | 400 | 500 | 630 | 800 | 1000 | 1250 | 1600 | 2000 | 2500 | 3150 | 4000 | 5000 |
| RT | 1.225 | 1.582 | 2.767 | 4.174 | 4.929 | 5.844 | 6.221 | 6.859 | 5.882 | 5.059 | 4.99 | 4.789 | 4.495 | 4.105 | 3.288 | 2.98 | 3.049 | 2.558 |
| (sec) | | | | | | | | | | | | | | | | | | |
| RT | 1.165 | 1.573 | 2.611 | 3.298 | 4.008 | 4.079 | 4.233 | 4.129 | 3.824 | 3.284 | 3.075 | 2.718 | 2.306 | 2.078 | 1.784 | 1.728 | 1.816 | 1.627 |
| (sec) | | | | | | | | | | | | | | | | | | |
| A | 1.40 | 0.14 | 0.72 | 2.08 | 1.53 | 2.42 | 2.47 | 3.15 | 2.99 | 3.49 | 4.08 | 5.19 | 6.89 | 7.74 | 8.35 | 7.90 | 7.20 | 7.20 |
| α | 0.12 | 0.01 | 0.06 | 0.17 | 0.13 | 0.20 | 0.21 | 0.26 | 0.25 | 0.29 | 0.34 | 0.43 | 0.57 | 0.65 | 0.70 | 0.66 | 0.60 | 0.60 |

The test results provide evidence of a particularly advantageous sound-absorption behaviour at frequencies between 1250 Hz to 5000 Hz, where the absorption coefficient α of more than 0.40 is reached.

### Example 2

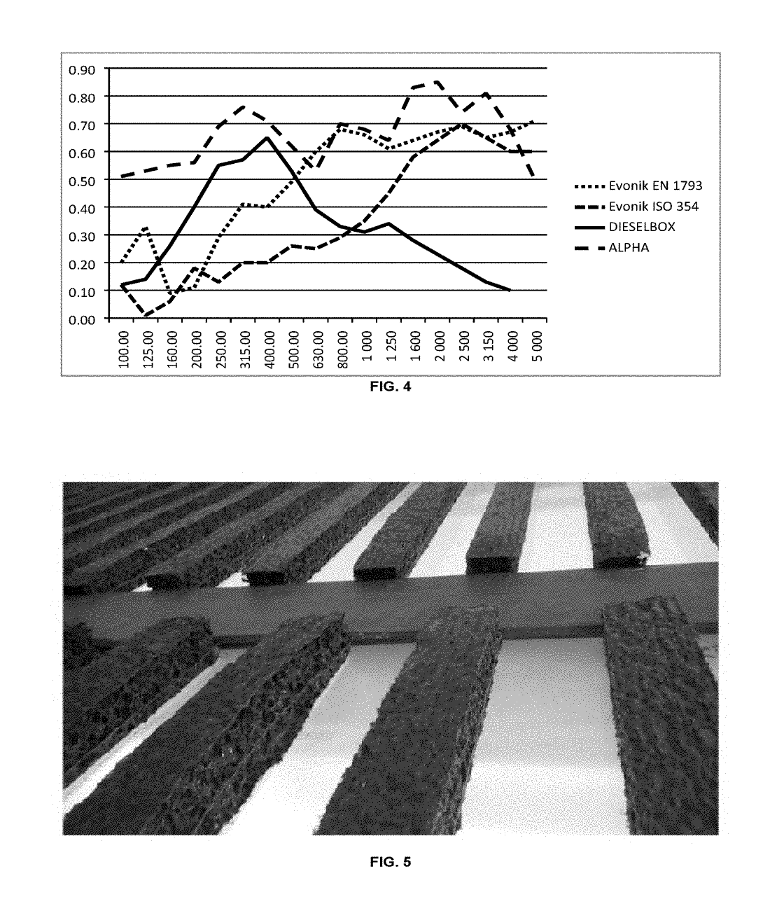

In a 25 mm thick PMMA plate (PLEXIGLAS® Soundstop GS CC, commercially available from Evonik Performance Materials GmbH, length: 1000 mm, height: 1000 mm), multiple rectangular recesses were milled out at an interval of 125 mm (see FIG. 5). Rectangular foam strips having a 40×50 mm cross section were inserted into the prepared recesses.

Thereafter, the acoustic properties of the noise protection element were determined in accordance with standard EN 1793. The measurement results are compiled in Table 4.

TABLE 4
Absorption coefficient α

| | |
|---|---|
| 100 | 0.20 |
| 125 | 0.33 |
| 160 | 0.09 |
| 200 | 0.11 |
| 250 | 0.29 |
| 315 | 0.41 |
| 400 | 0.40 |
| 500 | 0.49 |
| 630 | 0.60 |
| 800 | 0.68 |
| 1000 | 0.66 |
| 1250 | 0.61 |
| 1600 | 0.64 |
| 2000 | 0.67 |
| 2500 | 0.69 |
| 3150 | 0.65 |
| 4000 | 0.67 |
| 5000 | 0.71 |
| DLα | 4 dB |
| Sound absorber class | A2 |

This noise protection element, too, has very good noise-absorption properties.

Comparison with Commercially Available Noise Protection Elements

The sound-absorption behaviour of the tested noise protection elements from Example 1 (EVONIK (ISO 354)) and Example 2 (EVONIK (EN 1793)) were compared with the behaviour of the two commercially available noise protection elements:
Dieselbox (available from Dieselbox SA) and
Alpha (available from Alpha Acoustiki Ltd.)

The two commercially available noise protection elements have a comparatively complex structure and their acquisition and assembly is associated with correspondingly high costs. Furthermore, it should be noted that the noise-control system Alpha is non-transparent.

The results of the comparison are compiled in Table 5 and depicted graphically in FIG. 4.

TABLE 5

| | EVONIK | EVONIK | | |
|---|---|---|---|---|
| Frequency | (EN 1793) | (ISO 354) | DIESELBOX | ALPHA |
| 100 | 0.2 | 0.12 | 0.12 | 0.51 |
| 125 | 0.33 | 0.01 | 0.14 | 0.53 |
| 160 | 0.09 | 0.06 | 0.26 | 0.55 |
| 200 | 0.11 | 0.18 | 0.40 | 0.56 |
| 250 | 0.29 | 0.13 | 0.55 | 0.69 |
| 315 | 0.41 | 0.2 | 0.57 | 0.76 |
| 400 | 0.4 | 0.2 | 0.65 | 0.71 |
| 500 | 0.49 | 0.26 | 0.53 | 0.62 |
| 630 | 0.6 | 0.25 | 0.39 | 0.53 |
| 800 | 0.68 | 0.29 | 0.33 | 0.70 |
| 1000 | 0.66 | 0.35 | 0.31 | 0.68 |
| 1250 | 0.61 | 0.45 | 0.34 | 0.64 |
| 1600 | 0.64 | 0.58 | 0.28 | 0.83 |
| 2000 | 0.67 | 0.64 | 0.23 | 0.85 |
| 2500 | 0.69 | 0.7 | 0.18 | 0.74 |
| 3150 | 0.65 | 0.65 | 0.13 | 0.81 |
| 4000 | 0.67 | 0.6 | 0.10 | 0.68 |
| 5000 | 0.71 | 0.6 | | 0.50 |

The comparison shows that the noise protection elements according to the invention have particularly good noise-absorption properties in the range between 315 Hz to 5000 Hz. Especially in the region above 1000 Hz, the noise-absorption coefficient α of the noise protection elements according to the invention is higher than in the case of the commercially available product Dieselbox.

The noise-control system Alpha has particularly good noise absorption; however, this product is technically complex and non-transparent.

1. A noise protection element, comprising a plate comprising a transparent material, wherein a noise-absorbing material has been applied on at least one of the two surfaces of the plate,
wherein
the noise-absorbing material is a closed-pore polymer foam.

2. The noise protection element according to claim 1, wherein the transparent material comprises at least one polymer selected from the group consisting of polyalkyl (meth)acrylate, polycarbonate and polyalkyl (meth)acrylimide.

3. The noise protection element according to claim 1, wherein the transparent material comprises polymethyl methacrylate.

4. The noise protection element according to claim 1, wherein at least one of the two surfaces of the plate is at least partly matted and/or the plate comprises a particulate scatterer.

5. The noise protection element according to claim 1, wherein the noise-absorbing material is a closed-pore polyethylene foam or a closed-pore polypropylene foam.

6. The noise protection element according to claim 1, wherein the noise-absorbing material forms on at least one side of the plate a regular or irregular pattern in the form of trees, bushes, branches or geometric shapes.

7. The noise protection element according to claim 1, wherein the noise-absorbing material has been applied on at least one side of the plate in the form of multiple strips arranged in parallel to one another.

8. The noise protection element according to claim 1, wherein the side of the plate to which a noise-absorbing material has been applied has multiple recesses which have been at least partly covered and/or filled by the noise-absorbing material.

9. The noise protection element according to claim 8, wherein the recesses form a pattern composed of straight lines running in parallel to one another, which lines extend across the entire surface of the plate.

10. The noise protection element according to claim 8, wherein the recesses have a triangular, trapezoidal, funnel-shaped, oval or rectangular cross section.

11. The noise protection element according to claim 1, wherein from 10% to 50% of at least one surface of the plate is covered by the noise-absorbing material.

12. A noise insulation method, comprising applying the noise protection element according to claim 1 in a noise protection barrier.

13. A noise protection barrier, comprising the noise protection element according to claim 1, wherein the noise-absorbing material has been applied to a traffic route-facing surface of a plate comprising a transparent material.
